(19) United States
(12) Patent Application Publication
(10) Pub. No.: US 2003/0094304 A1
(43) Pub. Date: May 22, 2003

(54) INSULATED CONDUCTOR FOR HIGH-VOLTAGE WINDINGS

(76) Inventors: MATS LEIJON, VASTERAS (SE); LI MING, VASTERAS (SE); GUNNAR KYLANDER, VASTERAS (SE); PETER CARTENSEN, HUDDINGE (SE); BENGT RYDHOLM, VASTERAS (SE); PER ANDERSSON, OREBRO (SE); PETER TEMPLIN, VASTRA FROLUNDA (SE)

Correspondence Address: OBLON SPIVAK MCCLELLAND MAIER & NEUSTADT, 1755 JEFFERSON DAVIS HIGHWAY, FOURTH FLOOR, ARLINGTON, VA, 22202

(21) Appl. No.: 09/147,320

(22) PCT Filed: May 27, 1997
(86) PCT No.: PCT/SE97/00903

(30) Foreign Application Priority Data
May 29, 1996 (SE) 9602079-7
May 29, 1996 (SE) 9602091-2

(51) Int. Cl. H01B 7/00

(52) U.S. Cl. 174/110 R

(57) ABSTRACT

An insulated conductor for high-voltage windings and electric machine, and rotating electric machine that use the insulated conductor. The insulated conductor is suitable for use in a high-voltage winding application for devices such as an electric machine and a rotating electric machine. A feature of the insulated conductor is that the conductor includes at least one strand, and an inner conductive layer that surrounds the at least one strand. An insulating layer surrounds the inner conductive layer, and an outer conductive layer surrounds the insulating layer. When arranged in this manner, and when the outer conductive layer is suitably configured to provide an equipotential surface, the insulated conductor provides relatively high resistance to breakdown when operating at high voltages.

### BACKGROUND OF THE INVENTION

1. Field of the Invention

The present invention relates in a first aspect to an insulated conductor for high voltage windings in electric machines and in a second aspect to a rotating electric machine or static electrical machine having the insulated conductor.

More particularly, the invention is applicable in rotating electric machines such as synchronous machines or asynchronous machines as well as static electrical machines such as power transformers and power reactors. The invention is also applicable in other electric machines such as dual-fed machines, and applications in asynchronous static current cascades, outer pole machines and synchronous flow machines, provided their windings use the insulated electric conductors of the type described above, and preferably at high voltages, referring to electric voltages exceeding 10 kV. A typical working range for an insulated conductor for high-voltage windings according to the invention may be 1-800 kV.

2. Discussion of the Background

In order to be able to explain and describe the machine, a brief description of a rotating electric machine will first be given exemplified on the basis of a synchronous machine. The first part of the description substantially relates to the magnetic circuit of such a machine and how it is constructed according to classical techniques. Since the magnetic circuit referred to in most cases is located in the stator, the magnetic circuit discussed below will normally be described as a stator with a laminated core, the winding of which will be referred to as a stator winding, and the slots in the laminated core for the winding will be referred to as stator slots or simply slots.

The stator winding is located in slots in the sheet iron core, the slots normally having a rectangular or trapezoidal cross section as that of a rectangle or a trapezoid. Each winding phase comprises a number of series-connected coil groups connected in series and each coil group comprises a number of series-connected coils connected in series. The different parts of the coil are designated “coil side” for the part which is placed in the stator and “end winding end” for that part which is located outside the stator. A coil comprises one or more conductors brought together in height and/or width.

Between each conductor there is a thin insulation, for example epoxy/glass fiber.

The coil is insulated from the slot with a coil insulation, that is, an insulation intended to withstand the rated voltage of the machine to earth (i.e., ground potential). As insulating material, various plastic, varnish and glass fiber materials may be used. Usually, so-called mica tape is used, which is a mixture of mica and hard plastic, especially produced to provide resistance to partial discharges, which can rapidly break down the insulation. The insulation is applied to the coil by winding the mica tape around the coil in several layers. The insulation is impregnated, and then the coil side is painted with a graphite-based paint to improve the contact with the surrounding stator which is connected to earth potential.

The conductor area of the windings is determined by the current intensity in question and by the cooling method used. The conductor and the coil are usually formed with a rectangular shape to maximize the amount of conductor material in the slot. A typical coil is formed of so-called Roebel bars, in which certain of the bars may be made hollow for hosting a coolant therein. A Roebel bar comprises a plurality of rectangular, parallel-connected copper conductors connected in parallel, which are transposed 360 degrees along the slot. Ringland bars with transpositions of 540 degrees and other transpositions also occur. The transposition is made so as to avoid the occurrence of circulating currents which are generated in a cross section of the conductor material, as viewed from the magnetic field.

For mechanical and electrical reasons, a machine cannot be made in just any size. The machine power is determined substantially by three factors:

The conductor area of the windings. At normal operating temperature, copper, for example, has a maximum value of 3-3.5 A/mm2.

The maximum flux density (magnetic flux) in the stator and rotor material.

The maximum electric held strength in the insulating material, the so-called dielectric strength.

Polyphase AC windings are designed either as single-layer or two-layer windings. In the case of single-layer windings, there is only one coil side per slot, and in the case of two-layer windings there are two coil sides per slot. Two-layer windings are usually designed as diamond windings, whereas the single-layer windings which are relevant in this connection may be designed as a diamond winding or as a concentric winding. In the case of a diamond winding, only one coil span (or possibly two coil spans) occurs, whereas flat windings are designed as concentric windings, that is, with a greatly varying coil span. By coil span it is meant the distance in circular measure between two coil sides belonging to the same coil, either in relation to the relevant pole pitch or in the number of intermediate slot pitches. Usually, different variants of chording are used, for example short-pitching pitch, to give the winding the desired properties.

The type of winding substantially describes how the coils in the slots, that is, the coil sides, are connected together outside the stator, that is, at the end windings ends.

Outside the stacked sheets of the stator, the coil is not provided with a painted conductive earth-potential layer. The end winding end is normally provided with an E-field control in the form of so-called corona protection varnish intended to convert a radial field into an axial field, which means that the insulation on the end windings ends occurs at a high potential relative to earth. This sometimes gives rise to corona in the end-winding-end region, which may be destructive. The so called field-controlling points at the end windings ends entail problems for a rotating electric machine.

Normally, all large machines are designed with a two-layer winding and equally large coils. Each coil is placed with one side in one of the layers and the other side in the other layer. This means that all the coils cross each other in the end winding end. If more than two layers are used, these crossings render the winding work difficult and deteriorate the end winding end.

It is generally known that the connection of a synchronous machine/generator to a power network must be made via a [symbol] /YD-connected so-called step-up transformer, since the voltage of the power network normally lies at a higher level than the voltage of the rotating electric machine. Together with the synchronous machine, this transformer thus constitutes integrated parts of a plant. The transformer constitutes an extra cost and also has the disadvantage that the total efficiency of the system is lowered. If it were possible to manufacture machines for considerably higher voltages, the step-up transformer could thus be omitted.

During the last few decades, there have been increasing requirements for rotating electric machines for higher voltages than for what has previously been possible to design. The maximum voltage level which, according to the state of the art, has been possible to achieve for synchronous machines with a good yield in the coil production is around 25-30 kV.

Certain attempts to identify a new approach as regards the design of synchronous machines are described, inter alia, in an article entitled “Water-and-oil-cooled Turbogenerator TVM-300” in J. Elektrotechnika, No. 1, 1970, pp. 6-8, in U.S. Pat. No. 4,429,244 entitled “Stator of Generator”, and in Russian patent document CCCP Patent 955369.

The water-and oil-cooled synchronous machine described in J. Elektrotechnika is intended for voltages up to 20 kV. The article describes a new insulation system consisting of oil/paper insulation, which makes it possible to immerse the stator completely in oil. The oil can then be used as a coolant while at the same time using it as insulation. To prevent oil in the stator from leaking out towards the rotor, a dielectric oil-separating ring is provided at the internal surface of the core. The stator winding is made from conductors with an oval hollow shape provided with oil and paper insulation. The coil sides with their insulation are secured to the slots made with rectangular cross section by means of wedges, as coolant oil is used both in the hollow conductors and in holes in the stator walls. Such cooling systems, however, entail a large number of connections of both oil and electricity at the coil ends. The thick insulation also entails an increased radius of curvature of the conductors, which in turn results in an increased size of the winding overhang.

The above-mentioned US patent relates to the stator part of a synchronous machine which comprises a magnetic core of laminated sheet with trapezoidal slots for the stator winding. The slots are tapered since the need for insulation of the stator winding is less towards the interior of the rotor where that part of the winding which is located nearest the neutral point is located. In addition, the stator part comprises a dielectric oil-separating cylinder nearest the inner surface of the core. This part may increase the magnetization requirement relative to a machine without this ring. The stator winding is made of oil-immersed cables with the same diameter for each coil layer. The layers are separated from each other by way of spacers in the slots and secured by wedges. What is special for the winding is that it comprises two so-called half-windings connected in series. One of the two half windings is located, centered, inside an insulating sleeve. The conductors of the stator winding are cooled by surrounding oil. Disadvantages with such a large quantity of oil in the system are the risk of leakage and the considerable amount of cleaning work which may result from a fault condition. Those parts of the insulating sleeve which are located outside the slots have a cylindrical part and a conical termination reinforced with current-carrying layers, the purpose of which is to control the electric field strength in the region where the cable enters the end winding.

From CCCP 955369 it is clear, in another attempt to raise the rated voltage of the synchronous machine, that the oil-cooled stator winding comprises a conventional high-voltage cable with the same dimension for all the layers. The cable is placed in stator slots formed as circular, radially located openings corresponding to the cross-section area of the cable and the necessary space for fixing and for coolant. The different radially located layers of the winding are surrounded by and fixed in insulating tubes, insulating spacers fix the tubes in the stator slot. Because of the oil cooling, an internal dielectric ring is also needed here for sealing the oil coolant off against the internal air gap. The disadvantages of oil in the system described above also apply to this design. The design also exhibits a very narrow radial waist between the different stator slots, which implies a large slot leakage flux which significantly influences the magnetization requirement of the machine.

A report from Electric Power Research Institute, EPRI, EL-3391 from 1984 describes a review of machine concepts for achieving a higher voltage of a rotating electric machine with the purpose of being able to connect a machine to a power network without an intermediate transformer. Such a solution, judging from results of the investigation, provides good efficiency gains and great economic advantages. The main reason for considering it possible in 1984 to start developing generators for direct connection to power networks was that, at the time, a super conducting rotor had been produced. The large magnetization capacity of the super conducting field makes it possible to use an air gap winding with a sufficient insulation thickness to withstand the electrical stresses. By combining the most promising concept, according to the project, of designing a magnetic circuit with a winding, a so-called “monolith cylinder armature”, a concept where the winding comprises two cylinders of conductors concentrically enclosed in three cylindrical insulating casings and the whole structure being fixed an iron core without teeth, it was judged that a rotating electric machine for high voltage could be directly connected to a power network. The solution meant that the main insulation had to be made sufficiently thick to cope with network-to-network and network-to-earth potentials. The insulation system which, after a review of all the techniques known at the time, was judged to be necessary to manage an increase to a higher voltage was that which is normally used for power transformers and which consists of dielectric-fluid-impregnated cellulose press board. Clear disadvantages with to the proposed solution are that, in addition to requiring a super conducting rotor, it requires a very thick insulation which increases the size of the machine. The end windings ends must be insulated and cooled with oil or freons to control the large electric fields in the ends. The whole machine must be hermetically enclosed to prevent the liquid dielectric from absorbing moisture from the atmosphere.

When manufacturing rotating electric machines according to the state of the art, the winding is manufactured with conductors and insulation systems in several steps, whereby the winding must be preformed prior to mounting on the magnetic circuit. Impregnation for preparing the insulation system is performed after mounting of the winding on the magnetic circuit.

### SUMMARY OF THE INVENTION

It is an object of the invention is to be able to manufacture a rotating electric machine for high voltage without any complicated preforming of the winding and without having to impregnate the insulation system after mounting of the winding.

To increase the power of a rotating electrical machine, it is known to increase the current in the AC coils. This has been achieved by optimizing the quantity of conducting material, that is, by close-packing of rectangular conductors in the rectangular rotor slots. The aim was to handle the increase in temperature resulting from this by increasing the quantity of insulating material and using more temperature-resistant and hence more expensive insulating materials. The high temperature and field load on the insulation has also caused problems with the life of the insulation. In the relatively thick-walled insulating layers which are used for high-voltage equipment, for example impregnated layers of mica tape, partial discharges, PD, constitute a serious problem. When manufacturing these insulating layers, cavities, pores, and the like, will easily arise, in which internal corona discharges arise when the insulation is subjected to high electric held strengths. These corona discharges gradually degrade the material and may lead to electric breakdown through the insulation.

The present invention is based on the realization that, to be able to increase in the power of a rotating electrical machine in a technically and economically justifiable way, this must be achieved by ensuring that the insulation is not broken down by the phenomena described above. This can be achieved according to the invention by using as insulation layers made in such a way that the risk of cavities and pores is minimal, for example extruded layers of a suitable solid insulating material, such as thermoplastic resins, cross linked thermoplastic resins, rubber such as silicone rubber, etc. In addition, it is important that the insulating layer has an inner layer, surrounding the conductor, with semiconducting properties and that the insulation is also provided with at least one additional outer layer, surrounding the insulation, with semiconducting properties. By semiconducting properties is meant in this context a material which has a considerably lower conductivity than an electric conductor but which does not have such a low conductivity that it is an insulator. By using only insulating layers which may be manufactured with a minimum of defects and, in addition, providing the insulation with an inner and an outer conductive layer, it can be ensured that the thermal and electric loads are reduced. The insulating part with at least one adjoining conductive layer should have essentially the same coefficient of thermal expansion. At temperature gradients, defects caused by different temperature expansion in the insulation and the surrounding layers should not arise. The electric load on the material decreases as a consequence of the fact that the conductive (actually semiconductive) layers around the insulation will constitute equipotential surfaces and that the electrical field in the insulating part will be distributed relatively evenly over the thickness of the insulation. The outer conductive layer may be connected to a chosen potential, for example earth potential. This means that, for such a cable, the outer casing of the winding in its entire length may be kept at, for example, earth potential. The outer layer may also be cut off at suitable locations along the length of the conductor and each cut-off partial length may be directly connected to a chosen potential. Around the outer conductive layer there may also be arranged other layers, casings and the like, such as a metal shield and a protective sheath.

Further knowledge gained in connection with the present invention is that increased current load leads to problems with electric (E) field concentrations at the corners at a cross section of a coil and that this entails large local loads on the insulation there. Likewise, the magnetic (B) field in the teeth of the stator will be concentrated at the corners. This means that magnetic saturation arises locally and that the magnetic core is not utilized in full and that the wave form of the generated voltage/current will be distorted. In addition, eddy-current losses caused by induced eddy currents in the conductors, which arise because of the geometry of the conductors in relation to the B field, will entail additional disadvantages in increasing current densities. Further improvement of the invention is achieved by making the coils and the slots in which the coils are placed essentially circular instead of rectangular. By making the cross section of the coils circular, these will be surrounded by a constant B field without concentrations where magnetic saturation may arise. Also the E field in the coil will be distributed evenly over the cross section and local loads on the insulation are considerably reduced. In addition, it is easier to place circular coils in slots in such a way that the number of coil sides per coil group may increase and an increase of the voltage may take place without the current in the conductors having to be increased. The reason for this being that the cooling of the conductors is facilitated by, on the one hand, a lower current density and hence lower temperature gradients across the insulation and, on the other hand, by the circular shape of the slots which entails a more uniform temperature distribution over a cross section. Additional improvements may also be achieved by composing the conductor from smaller parts, so-called strands. The strands may be insulated from each other and only a small number of strands may be left uninsulated and in contact with the inner conductive layer, to ensure that the inner conductive layer of the insulator is at the same potential as the conductor.

The advantages of using a rotating electric machine according to the invention include that the machine can be operated at overload for a considerably longer period of time than what is usual for such machines without being damaged. This is a consequence of the composition of the machine and the limited thermal load of the insulation. It is, for example, possible to load the machine with up to 100% overload for a period exceeding 15 minutes and up to two hours.

One embodiment according to the invention is that the magnetic circuit of the rotating electric machine includes a winding of a threaded cable with one or more extruded insulated conductors with solid insulation with a conductive layer both at the conductor and the casing. The outer conductive layer may be connected to earth potential. To be able to cope with the problems which arise in case of direct connection of rotating electric machines to all types of high-voltage power networks, a machine according to the invention has a number of features which distinguish it from the state of the art.

As described above, a winding for a rotating electric machine may be manufactured from a cable with one or more extruded insulated conductors with solid insulation with a conductive layer (which may include a semiconductive layer) both at the conductor and at the casing.

Some typical examples of insulating materials are thermoplastics like LDPE (low density polyethylene), HDPE (high density polyethylene), PP (polypropylene), PB (polybutylene), PMP (polymethylpentene) or cross-linked materials like XLPE (cross linked polyethylene) or rubber insulation like EPR (ethylene propylene rubber) or silicone rubber.

A further development of a conductor composed of strands is possible in that it is possible to insulate the strands with respect to each other in order to reduce the amount of eddy current losses in the conductor. One or a few strands may be left uninsulated to ensure that the conductive layer which surrounds the conductor is at the same potential as the conductor.

It is known that a high-voltage cable for transmission of electric energy is composed of conductors with solid extruded insulation with an inner and an outer conductive part. In the process of transmitting electric energy it was required that the insulation should be free from defects. During transmission of electric energy, the starting-point has long been that the insulation should be free from defects. When using high-voltage cables for transmission of electric energy, the aim was not to maximize the current through the cable since space is no limitation for a transmission cable.

Insulation of a conductor for a rotating electric machine may be applied in some other way than by way of extrusion, for example by spraying or the like. It is important, however, that the insulation should have no defects through the whole cross section and should possess similar thermal properties. The conductive layers may be supplied with the insulation in connection with the insulation being applied to the conductors.

Preferably, cables with a circular cross section are used. Among other things, to obtain a better packing density, cables with a different cross section may be used.

To build up a voltage in the rotating electric machine, the cable is arranged in several consecutive turns in slots in the magnetic core. The winding can be designed as a multi-layer concentric cable winding to reduce the number of end winding-end crossings. The cable may be made with tapered insulation to utilize the magnetic core in a better way, in which case the shape of the slots may be adapted to the tapered insulation of the winding.

A significant advantage of a rotating electrical machine according to the invention is that the E field is near zero in the end-winding-end region outside the outer conductive layer and that with the outer casing at earth potential, the electric field need not be controlled. This means that no field concentrations can be obtained, neither within sheets, in end-winding-end regions or in the transition therebetween.

The present invention also relates to a method for manufacturing the magnetic circuit and, in particular, the winding. The method for manufacturing includes placing the winding in the slots by threading a cable into the openings in the slots in the magnetic core. Since the cable is flexible, it can be bent and this permits a cable length to be located in several turns in a coil. The end windings ends will then have bending zones in the cables. The cable may also be joined in such a way that its properties remain constant over the cable length. This method entails considerable simplifications compared with the state of the art. The so-called Roebel bars are not flexible but must be preformed into the desired shape. Impregnation of the coils is also an exceedingly complicated and expensive technique when manufacturing rotating electric machines today.

This is achieved with an insulated conductor for high-voltage windings in rotating electric machines as described herein. The high-voltage cable according to the present invention includes one or more strands surrounded by a first conductive layer. This first conductive layer is in turn surrounded by a first insulating layer which is surrounded by a second conductive layer. This second conductive layer is connected to ground potential at least two different points along the high-voltage cable, i.e., at the inlet and outlet of the stator. The second conductive layer has a resistivity which on the one hand minimizes the electric losses in the second conductive layer, and on the other hand contributes to the voltage induced in the second conductive layer minimizing the risk of glow discharges.

By way of the high-voltage cable according to the invention, described above, a high-voltage cable is obtained in which electric losses caused by induced voltages in the outer conductive layer can be avoided. A high-voltage cable is also obtained in which the risk of electrical discharges is minimized. Furthermore, this is obtained with a cable which is simple to manufacture.

### BRIEF DESCRIPTION OF THE DRAWINGS

The invention will now be explained in more detail in the following description of preferred embodiments, with reference to the accompanying drawings in which:

FIG. 1 shows a cross section of a high-voltage cable according to the present invention;

FIG. 2 shows a basic diagram explaining what affects the voltage between the conductive surface and earth; and

FIGS. 3 is a graph illustrating the potential on the conductive surface in relation to the distance between grounded points.

### DETAILED DESCRIPTION OF PREFERRED EMBODIMENTS

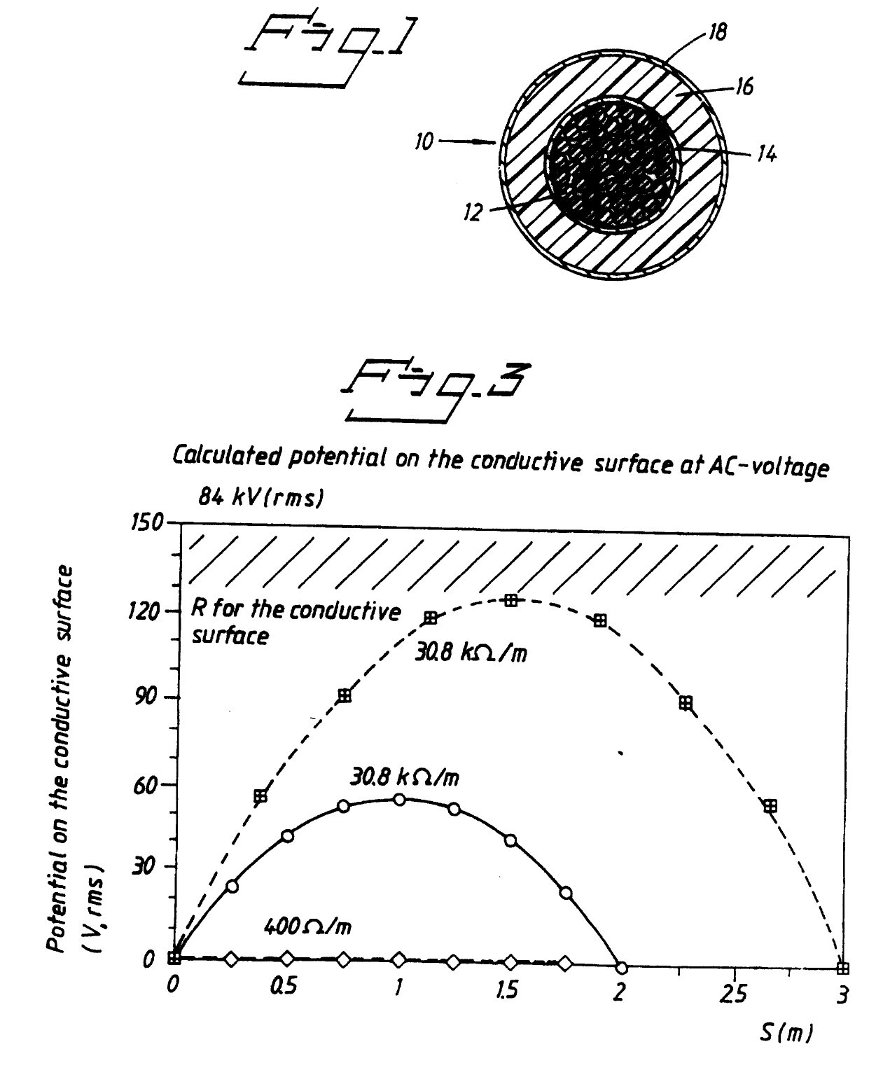

Referring now to the drawings wherein like reference numerals designate identical or corresponding parts throughout the several views, and more particularly to FIG. 1, FIG. 1 shows a cross-sectional view of a high-voltage cable 10 according to the present invention. The high-voltage cable 10 shown includes an electric conductor which may have one or more strands 12 of copper (Cu), for instance, having circular cross section. These strands 12 are arranged in the middle of the high-voltage cable 10. Around the strands 12 is a first conductive layer 14, and around the first conductive layer 14 is a first insulating layer 16, e.g., XLPE insulation. Around the first insulating layer 16 is a second conductive layer 18.

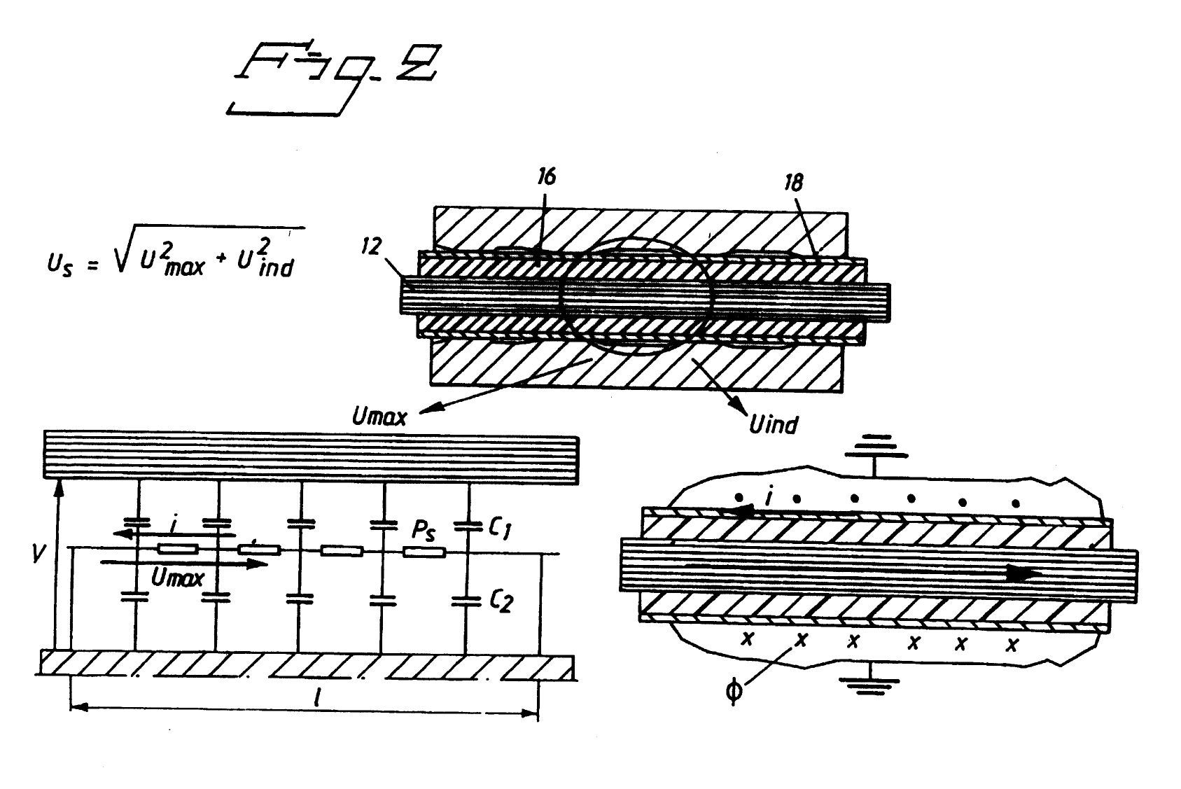

FIG. 2 shows a basic diagram explaining what affects the voltage between the second conductive surface and earth. The resultant voltage, Uₛ, between the surface of the second conductive layer 18 and earth may be expressed as follows:

Uₛ=\sqrt{U²ₘₐₓ+U²_{ind}} (1)

where Uₘₐₓ is the result of capacitive current in the surface and where U_{ind} is voltage induced from magnetic flux. To avoid surface discharges Uₛ must be <250 V, preferably Uₛ<130 through 150 V.

In principle U_{ind} creates no problems assuming grounding at both stator ends. Thus Uₛ≈Uₘₐₓ where the maximum value Uₘₐₓ at the middle of the conductor is given by

$${U}_{max} \approx {( 2 π f {C}_{1} {U}_{f} )}^{2} \frac{{ρ}_{s} {1}^{2}}{{A}_{s}}$$

where f=frequency; C₁=transverse capacitance per length unit; U_{f}=phase-to ground voltage; ρₛ=the resistivity of the conductive layer 18; Aₛ=the cross sectional area of the conductive layer 18, and 1=the length of the stator.

One way of preventing losses caused by induced voltages in the second conductive layer 18 is to increase its resistance. Since the thickness of the layer cannot be reduced for technical reasons relating to manufacture of the cable and stator, the resistance can be increased by selecting a coating or a compound that has higher resistivity.

If the resistivity is increased too much the voltage on the second conductive layer mid-way between the grounded points (that is, inside the stator) will be so high that there will be risk of glow discharge and consequently erosion of the conductive material and the insulation.

The resistivity ρₛ of the second conductive layer 18 should therefore lie within an interval:

ρₘᵢₙ<ρₛ<ρₘₐₓ (2)

where ρₘᵢₙ is determined by permissible power loss caused by eddy current losses and resistive losses caused by U_{ind}. ρₘₐₓ is determined by the requirement for no glow discharge.

Experiments have shown that the resistivity ps of the second conductive layer 18 should be between 10-500 ohm*cm. To obtain good results with machines of all sizes ρₛ should be between 50-100 ohm*cm.

FIG. 3 shows a diagram illustrating potentials on the conductive surface in relation to the distance between earthing points.

An example of a suitable conductive layer 18 is one manufactured of EPDM material mixed with carbon black. The resistivity can be determined by varying the type of base polymer and/or varying the type of carbon black and/or the proportion of carbon black.

The following are a number of examples of different resistivity values obtained using various mixtures of base polymer and carbon black.

| | | | Volume |
|---|---|---|---|
| | Carbon black | Carbon black | resistivity |
| Base polymer | type | quantity % | ohm*cm |
| Ethylene vinyl acetate | EC carbon black | approx. 15 | 350-400 |
| copolymer/nitrile rubber | | | |
| ″″ | P-carbon black | approx. 37 | 70-10 |
| ″″ | Extra conducting | approx. 35 | 40-50 |
| | carbon black, type | | |
| | I | | |
| ″″ | Extra conducting | approx. 33 | 30-60 |
| | carbon black, type | | |
| | II | | |
| Butyl grafted polythene | ″″ | approx. 25 | 7-10 |
| Ethylene butyl acrylate | Acetylene carbon | approx. 35 | 40-50 |
| copolymer | black | | |
| ″″ | P carbon black | approx. 38 | 5-10 |
| Ethylene propene rubber | Extra conducting | approx. 35 | 200-400 |
| | carbon black | | |

The invention is not limited to the embodiments shown. Several variations are feasible within the scope of the appended claims.

1. An insulated conductor (10) for high-voltage windings in electric machines, characterized in that the insulated conductor (10) comprises one or more strands (12), an inner, first conductive layer (14) surrounding the strands (12), a first insulating layer (16) surrounding the inner, first conductive layer (14) and an outer, second conductive layer (18) surrounding the first insulating layer (16), and the resistivity of the second conductive layer (18) is between 10-500 ohm*cm.

2. An insulated conductor (10) as claimed in claim 1, characterized in that the conductive layer (18) is earthed at at least two different points along the insulated conductor (10).

3. An insulated conductor (10) as claimed in claim 2, characterized in that the resistivity of the second conductive layer (18) is lower than that of the insulation layer (16) but higher than that of the material of the strands (12).

4. An insulated conductor (10) as claimed in claim 3, characterized in that the resistivity of the second conductive layer (18) is between 50-100 ohm*cm.

5. An insulated conductor (10) as claimed in claim 1, characterized in that the resistance per axial length unit of the second conductive layer (18) is between 5-50000 ohm/m.

6. An insulated conductor (10) as claimed in claim 1, characterized in that the resistance per axial length unit of the second conductive layer (18) is between 500-25000 ohm/m.

7. An insulated conductor (10) as claimed in claim 1, characterized in that the resistance per axial length unit of the second conductive layer (18) is between 2500-5000 ohm/m.

8. An insulated conductor (10) as claimed in any of the preceding claims, characterized in that the resistivity of the second conductive layer (18) is determined by varying the type of base polymer and varying the type of carbon black and the proportion of carbon black.

9. An insulated conductor (10) as claimed in claim 7, characterized in that the base polymer is chosen from ethylene butyl acrylatecopolymers of EP-rubber.

10. An insulated conductor (10) as claimed in claims 7-8, characterized in that the second conductive layer (18) is cross-linked by peroxide.

11. An insulated conductor (10) as claimed in any of the preceding claims, characterized in that the adhesion between the insulation layer (16) and the second conductive layer (18) is of the same order of magnitude as the intrinsic strength of the insulation material.

12. An insulated conductor (10) as claimed in any of the preceding claims, characterized in that the first conductive layer (14), the insulating layer (16) and the second conductive layer (18) are extruded on the conductive strands (12).

13. An insulated conductor (10) as claimed in claim 11, characterized in that all layers are applied through extrusion through a multi layer head.

14. An insulated conductor (10) as claimed in any of the preceding claims, characterized in that the insulating layer (16) is a crosslinked polyethylene, XLPE.

15. An insulated conductor (10) as claimed in any of the preceding claims, characterized in that the insulating layer (16) is made of ethylenepropylene rubber or silicone rubber.

16. An insulated conductor (10) as claimed in any of the preceding claims characterized in that the insulating layer (16) is made of a thermoplastic material as LDPE, HDPE, PP, PB, PMP.

17. An electric machine comprising an insulated conductor as claimed in any of claims 1-16.

18. An rotating electrical machine comprising an insulated conductor as claimed in any of claims 1-16.
